(19) United States
(12) Patent Application Publication
(10) Pub. No.: US 2004/0258839 A1
(43) Pub. Date: Dec. 23, 2004

(54) Oxidation protective multiple coating method for carbon/carbon composites

(75) Inventors: Soon Hyung Hong, Daejeon (KR); Yang Ho Bae, Daejeon (KR); Ji Young Song, Daejeon (KR)

Correspondence Address: STERNE, KESSLER, GOLDSTEIN & FOX PLLC, 1100 NEW YORK AVENUE, N.W., WASHINGTON, DC, 20005, US

(73) Assignee: Korea Advanced Institute of Science and Technology

(21) Appl. No.: 10/767,858

(22) Filed: Jan. 30, 2004

(30) Foreign Application Priority Data
Jan. 30, 2003 (KR) 10-2003-0006385

(51) Int. Cl. B05D 3/02

(52) U.S. Cl. 427/249.15; 427/253; 427/372.2

(57) ABSTRACT

This invention relates to methods of preparing oxidation protective multiple coating layers for carbon/carbon composites. More specifically, the invention is directed to a method of applying an oxidation protective multiple coating to a carbon/carbon composite. The method is characterized by the formation of two or more layers of coating on the carbon/carbon composite by using Si.

This application claims priority to Korean Patent Application No. 10-2003-0006385, filed Jan. 30, 2003, which is incorporated by reference herein in its entirety.

### BACKGROUND OF THE INVENTION

1. Field of the Invention

This invention relates to methods of preparing oxidation protective multiple coating layers for carbon/carbon composites. More specifically, the invention is directed to a method of applying an oxidation protective multiple coating to a carbon/carbon composite. The method is characterized by the formation of two or more layers of coating on the carbon/carbon composite by using Si.

2. Related Art

As is known to those skilled in the art, carbon/carbon composites have high heat conductivity, low coefficient of thermal expansion, and excellent strength and stiffness at high temperatures. However, when heated to 400° C. or higher in a general atmosphere, carbon/carbon composites react with oxygen in the air and are oxidized to carbon monoxide and carbon dioxide. The characteristics of the carbon/carbon composites are unavoidably degraded. Therefore, applications using carbon/carbon composites are limited to use in inert atmospheres.

Known coating techniques to prevent carbon/carbon composites from oxidation include pack cementation, chemical vapor deposit (CVD) and slurry coating. To decrease the number of cracks caused by a coating process, techniques have been developed that involve at least two layers of the coating rather than a single layer. Ceramic materials such as SiC, SiO₂, B₂O₃ and ZrO₂ have been the most popular coating materials due to their reduced reactivity. Since the mid-1960s, the pack cementation process has been employed in the protective coating of a super alloy used in hot gas turbines.

The use of a variety of pack compositions in the formation of SiC coatings on carbon/carbon composites was disclosed in U.S. Pat. Nos. 4,544,412, 4,425,407, 4,976,889 and 3,095,316. Pack compositions based on Al₂0₃, Si and SiC produce SiO gas. SiO gas is involved with carbon/carbon composites in the following reaction:

SiO (g)+2C (s)→SiC (s)+CO (g) Reaction 1

Boron can also be added to pack compositions, where it enhances the oxidation protection of carbon/carbon composites, as disclosed in U.S. Pat. Nos. 2,992,960, 3,374,102, 3,672,936 and 4,119,189. According to U.S. Pat. No. 3,935,034, the use of boron in larger amounts enhances the oxidation protection of carbon/carbon composites. However, when 1.5% (by weight) or more of boron is used, the pack is sintered, thus decreasing the reactivity between the pack and the composite. Furthermore, due to the sintered pack, coated products are difficult to recycle. The ideal amount of boron is therefore in the range of 0.2% (by weight) to 1.5% (by weight).

According to U.S. Pat. Nos. 4,976,899 and 4,425,407, the CVD process is used to produce the SiO gas in Reaction 1. In this reaction, the optimal reaction conditions depend on the ratios of [H₂]/[CH₃SiCl₃]and [C₄H_{10]/[CH}₃SiCl₃] in H₂, CH₃SiCl₃ and C₄H₁₀ gases.

The slurry coating process is used to coat the carbon/carbon composite with liquid silicon and boron. U.S. Pat. No. 3,936,574 discloses that the addition of 10% (by weight) to 35% (by weight) of boron enhances the oxidation protection of the composite. Furthermore, U.S. Pat. No. 4,148,894 discloses the use of a mold to impregnate the carbon/carbon composite with liquid Si while the furnace temperature is maintained at 1600° C. or higher, thereby forming Si and SiC coating layers and improving the oxidation resistance.

These techniques can be combined or used independently. A combination, for example, might include pack cementation and CVD, or pack cementation and slurry coating. U.S. Pat. Nos. 4,425,407 and 4,976,899 disclose multiple coating methods that reduce the number of cracks during the coating process.

These conventional coating methods, however, are disadvantageous because of their complicated coating processes, such as using organic materials when fixing the coating layer or using a mold during impregnation.

In addition, at least two coating materials are required to form two or more coating layers. A heat treatment process is also required to be carried out at 1600° C. or higher, thus decreasing the economic benefits.

### SUMMARY OF THE INVENTION

Coating layers required for carbon/carbon composites should have low volatility to prevent excessive oxidation in quick flowing gas. The coating layers should be uniform and dense to avoid an oxygen reaction with the carbon/carbon composites. Furthermore, carbon/carbon composites, which can be applied to high temperature areas, e.g. jigs for heat treatment or missile turbines, should not react with the contact material at high temperatures. Due to their low volatility and reactivity, general ceramic materials have consequently been proposed as coating materials that meet the requirements of the coating layers. General ceramic materials, however, have coefficients of thermal expansion (CTE) in the range of tens of parts per million (ppm), while carbon/carbon composites have a low CTE ranging from −1 ppm to 2 ppm. Thus, ceramic materials remarkably reduce the resistance to heat shock. Accordingly, to increase the oxidation resistance of carbon/carbon composites at high temperatures, uniform and dense coating layers with low volatility and a low CTE should be formed on the composite. However, a single process using only one method forms cracks due to the CTE difference during cooling.

An objective of this invention, therefore, is to alleviate the problems encountered in the art and to provide an oxidation protective multiple coating method. In the double coating method, a first coating process forms the initial layer on a carbon/carbon composite and a second coating process forms a layer made exclusively of Si over the initial layer. The total thickness of two or more layers is controlled and varied in the range of about 10 μm to about 2000 μm.

The present invention can be economically advantageous since the additional coating process for oxidation protection can be performed at 1600° C. or lower. Moreover, the simplicity of the method is highlighted by the fact that the carbon/carbon composite can be impregnated with Si even without a mold.

Another objective of the invention is to provide a carbon/carbon composite that has two or more uniform and dense coating layers with low volatility and a low CTE. Such layers increase the oxidation protection and enable the composite to be applied not only in a general atmosphere but also in an oxidation atmosphere.

To achieve these objectives, the present invention is directed to a method of making an oxidation protective multiple coating for a carbon/carbon composite, the method comprising (a) forming an initial coating layer on the carbon/carbon composite by a pack cementation process, (b) coating Si over the initial coating layer to form an Si-coated carbon/carbon composite, and (c) heat-treating the Si-coated carbon/carbon composite to impregnate the initial coating layer, and cracks in the initial coating layer, with Si, thereby forming an SiC layer and an Si layer.

In some embodiments, the method of the present invention further comprises oxidizing the Si layer to form an SiO₂ film.

In brief, a known pack cementation process can form the initial coating layer and the initial coating layers, and cracks in the initial layer, are impregnated with Si. Consequently, the impregnation with Si leads to the formation of a denser SiC coating layer and a significant reduction in the number of cracks.

### BRIEF DESCRIPTION OF THE FIGURES

FIG. 1 illustrates the structure of a graphite mold used in the examples described below.

FIG. 2 is an scanning electron micrograph illustrating a section of a carbon/carbon composite coated in the manner described in Example 1.

FIG. 3 is an scanning electron micrograph illustrating a section of a carbon/carbon composite coated in the manner described in Example 9, after the carbon/carbon composite had been subjected to an oxidation test (three coatings).

### DETAILED DESCRIPTION OF THE INVENTION

The present invention is directed to a method of making an oxidation protective multiple coating for a carbon/carbon composite, the method comprising, (a) forming an initial coating layer on the carbon/carbon composite by a pack cementation process, (b) coating Si over the initial coating layer to form an Si-coated carbon/carbon composite, and (c) heat-treating the Si-coated carbon/carbon composite to impregnate the initial coating layer, and cracks in the initial coating layer, with Si, thereby forming an SiC layer and an Si layer.

In some embodiments, the present invention is directed to a coated carbon/carbon composite made according to the method of the present invention.

A carbon/carbon composite coated by the multiple coating method of the present invention can be used in jigs for heat treatment, hot structures, and fasteners such as nuts and bolts used for fixing targets at high temperatures.

In the coating method of the present invention, the formation of the initial coating layer by a pack cementation process can be performed according to known methods (U.S. Pat. No. 3,935,034; Paccaud, O. and Derre. A., Chem. Vap. Deposition 1:33 (2000)). The formation of the SiC coating as the initial coating layer is described below in Example 1. Briefly, a pack comprising SiC:Si:SiO₂at a ratio of about 6:3:1 is used. The pack is uniformly mixed and then charged into a graphite mold along with the carbon/carbon composite.

The production of SiO gas required for the formation of an SiC coating layer on the carbon/carbon composite gradually increases at about 1500° C. and abundantly increases at about 1770° C. Thus, the pack cementation process can be conducted from about 1650° C. to about 1770° C. Furthermore, after being coated by pack cementation, the composite exhibits higher oxidation protective properties for a prolonged retention time at the coating temperatures; however, the retention time falls after about 4 hours to about 10 hours. The coated composite is also subjected to a cooling process in the range of about 1° C./min to about 10° C/min to minimize heat shock after the coating process, thereby minimizing the number of cracks caused by the heat shock.

To apply the coating, a spray gun can be used to spray a powdered form of Si. Any Si powder can be used as long as it has a mesh size of from about 60 mesh to about 325 mesh and is suitable for uniform coating and impregnation into the carbon/carbon composites.

Si powder can be mixed with a vehicle liquid and then sprayed on carbon/carbon composites. During spraying, the vehicle liquid can be used to coat Si uniformly onto the carbon/carbon composite. Any vehicle liquid can be used as long as it has high volatility at room temperature, e.g., alcohols such as ethanol or methanol. After drying at room temperature for 24 hours, the vehicle liquid should evaporate, leaving only Si on the composite.

The impregnation of the composite with Si involves a process of melting the Si. The melting process is performed by heat-treating the Si coating on the composite between about 1400° C. and about 1600° C. To prevent the carbon/carbon composite from oxidizing at high temperatures, the pressure should preferably be in the range of about 10 mTorr to about 1000 mTorr during heat treatment. The coating method is economically beneficial since high temperature procedures, which are conventionally conducted at 1600° C. or higher, are not required for this invention.

To yield an SiC layer and then an Si layer, an additional heat treatment is carried out at about 1400° C. to about 1600° C., which is the same temperature range as the melting process.

The carbon/carbon composite coated by the method of the invention includes double coatings composed sequentially of the SiC layer and the Si layer. The two layers can be conveniently used to improve the oxidation protection of the carbon/carbon composite.

When the carbon/carbon composite is used in an environment where the temperature reaches about 1700° C. or higher, e.g., in jigs or heaters of heat treatment furnaces, a double coating containing Si and SiC can be inappropriate, and an SiO₂ film should be formed on the Si coating layer.

The formation of an SiO₂ film involves a process of heat treatment of the Si-coated carbon/carbon composite. During heat treatment, oxygen from the general atmosphere reacts with Si at high temperatures. Limitations are not imposed on the reaction temperature. The reaction is vigorously progressed at higher temperatures. However, after the cooling process, a larger number of cracks can appear due to shrinkage of the composite. Thus, the reaction temperature is therefore limited to a range of about 400° C. to about 800° C.

As seen in FIG. 3, the resultant coating layers on the carbon/carbon composite are uniform and dense. The total thickness of the coating layers can be freely set by controlling the amount of Si used in the coating, according to the characteristics required for the carbon/carbon composite. That is, the thickness of the coating layers can vary from about 10 μm to about 2000 μm, depending on the amount of Si to be used in the coating.

A better understanding of the invention can be obtained by referring to specific examples. The examples provided here are for illustration only and are not intended to be limiting unless otherwise specified.

### EXAMPLE 1

### Preparation of Two Coatings

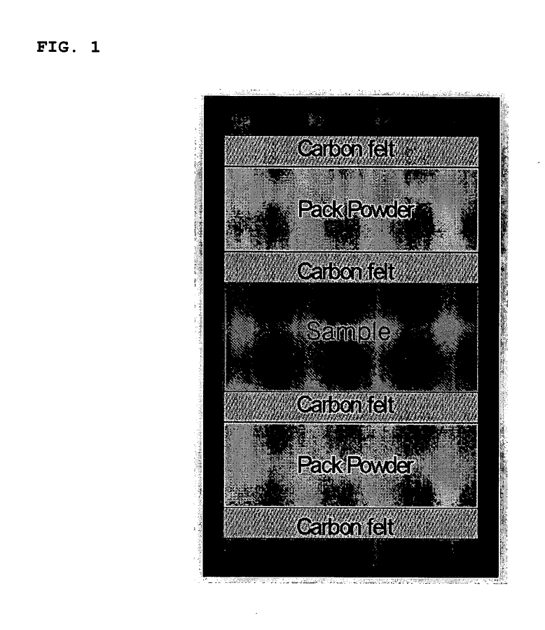

Powders of SiC, Si and SiO₂ were prepared at a ratio of 6:3:1 and uniformly mixed by the use of a ball-milling method. The mixed pack of powders was charged into the graphite mold shown in FIG. 1. The graphite mold was then heat-treated in a heat treatment furnace at 1770° C. for 4 hours under vacuum and then cooled, yielding an SiC coating layer on the carbon/carbon composite. The SiC coating layer was obtained by a reaction of the SiO produced from the pack of powders at high temperatures and the C of the carbon/carbon composite.

To apply a second coat to the carbon/carbon composite after the initial coating, a coating solution was prepared by mixing 10 g of only Si particles with an average diameter of 60 mesh and 100 ml of ethanol. The solution was put in a spray gun and sprayed uniformly to coat the composite. The composite was then dried at room temperature for 24 hours to volatilize the ethanol. The Si-coated composite was then heated at 1400° C. for one hour at about 50 mTorr to melt the Si and to impregnate the carbon matrix with the Si.

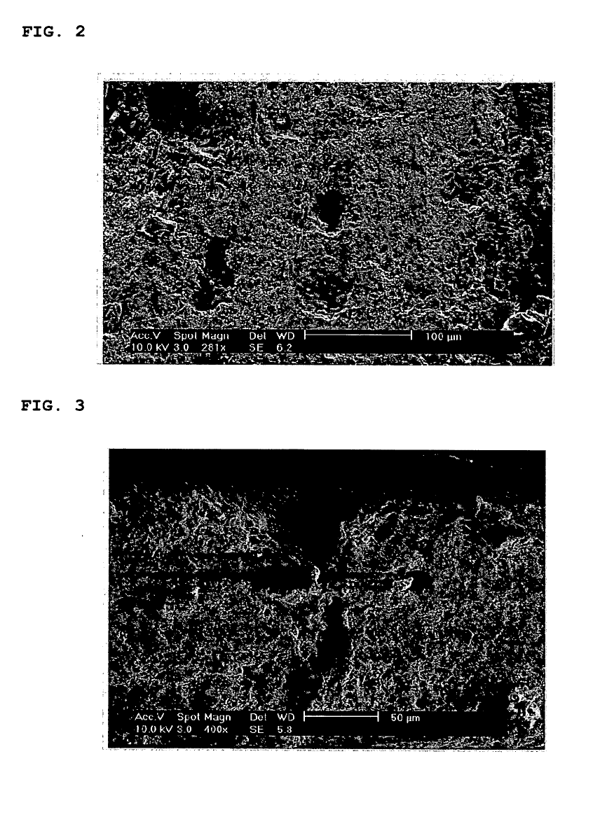

This method resulted in a carbon/carbon composite composed of 2 layers, an SiC layer and an Si layer. As shown in FIG. 2, the total coating thickness was 250 μm.

### EXAMPLE 2

### Preparation of Two Coatings

Two coating layers were prepared in the same manner as in Example 1, except that Si powder with an average diameter of 325 mesh was used. The total coating thickness was 250 μm.

### EXAMPLE 3

### Preparation of Two Coatings

Two coating layers were prepared in the same manner as in Example 1, except that the Si-coated composite was heated at 1600° C. The total coating thickness was 230 μm.

### EXAMPLE 4

### Preparation of Two Coatings

Two coating layers were prepared in the same manner as in Example 2, except that the Si-coated composite was heated at 1600° C. The total coating thickness was 230 μm.

### EXAMPLE 5

Preparation of Three Coatings

To coat a carbon/carbon composite (AC150 and AC200, Across Co. Ltd, Japan) containing an initial SiC layer, a coating solution was prepared by mixing 20 g of Si particles with an average diameter of 60 mesh and 100 ml of ethanol. The mixed solution was put in a spray gun and sprayed uniformly to coat the composite. The composite was then dried at room temperature for 24 hours to volatilize the ethanol.

The Si-coated composite was heated at 1400° C. to melt the Si so that the carbon matrix was impregnated with Si. The Si impregnated carbon matrix was then heated at the same temperature for 1 hour to produce an SiC layer and an Si layer.

The composite with the double-layered coating was then heat-treated at 400° C. for 6 hours, thereby producing an SiO₂ oxidation film on the Si layer.

The total coating thickness was 500 μm.

### EXAMPLE 6

### Preparation of Three Coatings

Three coating layers were prepared in the same manner as in Example 5, except that Si powder with an average diameter of 325 mesh was used. The total coating thickness was 500 μm.

### EXAMPLE 7

### Preparation of Three Coatings

Three coating layers were prepared in the same manner as in Example 5, except that the Si-coated composite was heated at 1600° C. The total coating thickness was 480 μm.

### EXAMPLE 8

### Preparation of Three Coatings

Three coating layers were prepared in the same manner as in Example 6, except that the Si-coated composite was heated at 1600° C. The total coating thickness was 480 μm.

### EXAMPLE 9

### Preparation of Three Coatings

Three coating layers were prepared in the same manner as in Example 5, except that the composite with the double-layered coating was heat-treated at 800° C. for an extra hour to form an SiO₂ oxidation film on the Si coating layer. As shown in FIG. 3, the total coating thickness was 500 μm.

### EXAMPLE 10

### Preparation of Three Coatings

Three coating layers were prepared in the same manner as in Example 9, except that the Si powder with an average diameter of 325 mesh was used. The total coating thickness was 500 μm.

### EXAMPLE 11

### Preparation of Three Coatings

Three coating layers were prepared in the same manner as in Example 9, except that the Si-coated composite was heated at 1600° C. The total coating thickness was 470 μm.

### EXAMPLE 12

### Preparation of Three Coatings

Three coating layers were prepared in the same manner as in Example 10, except that the Si-coated composite was heated at 1600° C. The total coating thickness was 465 μm.

### EXAMPLE 13

### Oxidation Test

A control group consisting of a non-coated carbon/carbon composite and an experimental group consisting of the carbon/carbon composite coated as in Example 9 were subjected to an oxidation test. The oxidation test was performed by measuring the weight loss after heat treatment in a box furnace.

Carbon/carbon composites were heated to 700° C. with a heating rate of 10° C./min and held at 700° C. for 2 hours in air. As a result, the rates of the weight loss were 84 percent for the control group and 3 percent for the experimental group. The oxidation protection of the invented composite is therefore 30 times better than that of the non-coated composite (FIG. 3). Moreover, since the carbon/carbon composite of the invention has coating layers made of ceramic materials, the composite is useful in an oxidation atmosphere and in applications that require no reaction with contact materials.

As described above, the invention provides an oxidation protective multiple coating method for a carbon/carbon composite. Two or more coating layers made exclusively of Si can be formed on the composite, and the total thickness of the coating layers is controlled in the range of about 10 μm to about 2000 μm, depending on the amount of Si to be used in the coating. Furthermore, the coating process can be performed at 1600° C. or lower, thus generating economic benefits. The carbon/carbon composite can also be impregnated with Si even without a mold, thereby simplifying the overall coating process.

Oxidation resistance enhances the coated carbon/carbon composite, enabling it to be used in an oxidation atmosphere and in a general atmosphere.

These examples illustrate possible methods of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method of making an oxidation protective multiple coating for a carbon/carbon composite, the method comprising:
(a) forming an initial coating layer on the carbon/carbon composite by a pack cementation process;
(b) coating Si over the initial coating layer to form an Si-coated carbon/carbon composite; and
(c) heat-treating the Si-coated carbon/carbon composite to impregnate the initial coating layer, and cracks in the initial coating layer, with Si;
thereby forming an SiC layer and an Si layer.

2. The method of claim 1, further comprising oxidizing the Si layer to form an SiO₂ film.

3. The method of claim 1, wherein a vehicle liquid is used to facilitate the coating of Si over the initial coating layer in (b).

4. The method of claim 3, wherein the vehicle liquid is a volatile alcohol.

5. The method of claim 1, wherein the heat-treating in (c) is performed at a temperature of about 1400° C. to about 1600° C. under a pressure of about 10 mTorr to about 1000 mTorr.

6. The method of claim 2, wherein the oxidizing of the Si layer is performed at a temperature of about 400° C. to about 800° C.

7. A coated carbon/carbon composite made according to the method of claim 1.

8. A coated carbon/carbon composite made according to the method of claim 2.
